(19) United States
(12) Patent Application Publication
(10) Pub. No.: US 2010/0235216 A1
(43) Pub. Date: Sep. 16, 2010

(54) INTEGRATION OF PRE-MEETING AND POST-MEETING EXPERIENCE INTO A MEETING LIFECYCLE

(75) Inventors: Alexander M. Hehmeyer, Bellevue, WA (US); Amit Gupta, Redmond, WA (US); Avronil Bhattacharjee, Redmond, WA (US); Felix W. Wong, Bellevue, WA (US); John H. Zybura, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/404,356

(22) Filed: Mar. 16, 2009

(51) Int. Cl. G06Q 10/00

(52) U.S. Cl. 705/9; 705/8

(57) ABSTRACT

Architecture that synchronizes meeting information (e.g., documents, agenda, action items, notes, attendees, join information, etc.) across the different stages of a meeting lifecycle. The architecture provides client-side synchronization across meeting lifecycle services that can include a scheduling server, content management server, and meeting server, as well as other lifecycle servers that may be employed. Information from the scheduling server can be written asynchronously to the other lifecycle servers, updates made to the content management server are synchronized to the other servers, and updates made to the meeting server are synchronized to the other servers.

### BACKGROUND

Meetings occur in the context of larger goals such as a project, creating a document, or establishing a team, for example. The meeting is a tool to get the work of the project done by bringing people together to exchange information and find solutions.

The current meeting experience (e.g., online) can be disjointed from the rest of a team's work. For example, consider that a team is organized and has all meeting materials (e.g., documents, video files, agenda, etc.) in one place and ready for use. Before an online meeting can start, all of these materials have to be uploaded to the online meeting application. Depending on the size of the files, this can take time to not only upload the files but to address overly large files that can be prohibitively large to upload, or once uploaded, to launch. Moreover, as part of this process, the online meeting application can convert the files into a format that works for the online meeting application, but is not reusable to the end user. New items created in the online meeting application, such as whiteboards, may also not be downloadable after the meeting so that the knowledge created during the meeting can be reused.

In the meeting lifecycle of pre-meeting, during the meeting, and post-meeting environments, there are many useful pieces of information that can be made part of the overall meeting lifecycle to provide a good end-to-end meeting experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a mechanism that synchronizes meeting information (e.g., recordings, documents, agenda, action items, notes, attendees, join information, etc.) between clients and servers throughout the different stages of the meeting lifecycle. The meeting lifecycle is the ordered stages of experience which an end-user goes through when interacting with a meeting or other collaborative session. These stages can include, but are not limited to, scheduling, pre-meeting, joining, in-meeting, and post-meeting. In the meeting experience, many different kinds of client software and server software can be used in the various stages.

Traditionally, there are different pieces of information created and utilized in different stages of the meeting lifecycle, as well as during different parts of the lifecycle stages. Additionally, there can be different combinations of client and server software employed during each stage such as a scheduling client and scheduling server, a content management server and, in-meeting client and in-meeting server, for example. Moreover, the same information can be used across the various stages and software, but oftentimes requires a user to manually move the information between the various stages, as needed. The disclosed architecture provides a framework that automatically ties all the information together across the different pieces of software, thereby making information management seamless to the users.

The lifecycle framework includes servers that provide functionality so that participants have an efficient and positive user experience. In support thereof, the architecture provides client-side synchronization between a scheduling server, document server, and meeting server, for example, as well as other lifecycle servers that may be employed. Additionally, in an alternative embodiment, the framework can also provide server-side synchronization between the servers.

Information from the scheduling solution can be written asynchronously to the other lifecycle servers (e.g., meeting server and document server). Similarly, updates made to the document server are synchronized to the scheduling and meeting servers, and updates made to the meeting server are synchronized to the scheduling and document servers. When the client goes offline, uploads and downloads can be queued such that when the client is back online, a retry engine facilitates the synchronization to the latest content.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented meeting lifecycle system in accordance with the disclosed architecture.

FIG. 2 illustrates a computer-implemented meeting lifecycle system that includes client-based synchronization.

FIG. 3 illustrates a generalized system for synchronizing meeting information between three lifecycle components.

FIG. 4 illustrates that synchronization to one lifecycle component can automatically facilitate synchronization to the other lifecycle components.

FIG. 5 illustrates a system where each lifecycle component communicates with a compatible client in a client-server relationship.

FIG. 6 illustrates one example of the stages of a meeting lifecycle framework.

FIG. 7 illustrates one implementation of a system showing components and data flow.

FIG. 8 illustrates a computer-implemented meeting lifecycle method.

FIG. 9 illustrates an alternative flow for a meeting lifecycle method.

FIG. 10 illustrates a method of presenting relevant meeting information during a stage of the lifecycle framework.

FIG. 11 illustrates a method of synchronizing meeting information to meeting lifecycle servers.

FIG. 12 illustrates a block diagram of a computing system operable to execute client synchronization of meeting information in accordance with the disclosed architecture.

FIG. 13 illustrates a schematic block diagram of a computing environment for meeting lifecycle client-based data synchronization.

### DETAILED DESCRIPTION

The disclosed architecture is a synchronization architecture for synchronizing meeting information across core meeting services, such as scheduling, document management and meeting management. Synchronization can be accomplished via client-side synchronization, server-side synchronization, or combination of both. Client synchronization can be accomplished via an email client, personal information manager (PIM) client, content management sharing client (e.g., via a collaborating application), and meeting environment (e.g., multi-modal communications). The meeting environment is conceptually defined as the multiple stages associated with a meeting lifecycle (as described herein) such as preparing, conducting, and completing a meeting, and the meeting information is that information which is created, utilized and synchronized as part of the multiple stages.

The content management experience links to the scheduling experience for updates to data associated with the invitation text, such as documents, presenter data, attendee data, meeting time data, and so on. The content management experience shows aspects of the meeting that are most interesting based on the phase (stage) of the meeting lifecycle the meeting currently occupies. For example, after the meeting, participant attendance can be shown, but before the meeting participant responses to the invitation are shown.

Information from the scheduling solution, including but not limited to invitation text, attached documents, attendee lists, meeting location, can be written asynchronously to the servers, for example, the meeting server and document server. Updates made to any one server are automatically synchronized to the other lifecycle servers, as needed. In other words, the meeting information can include information portions that provide updates to one server, but not another server.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

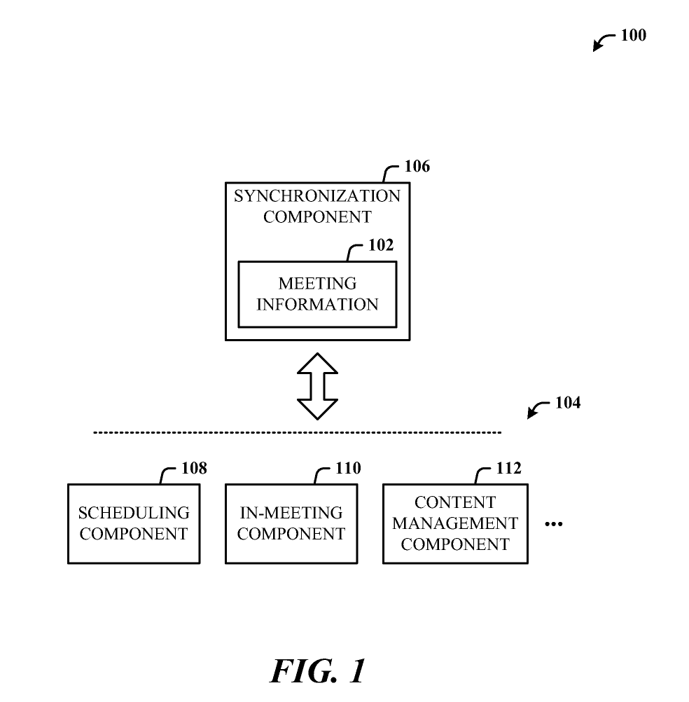

FIG. 1 illustrates a computer-implemented meeting lifecycle framework 100 in accordance with the disclosed architecture. The framework 100 includes a meeting environment represented as being associated with multiple stages of preparing, conducting, and completing a meeting. All stages associated with the meeting environment are involved with meeting information 102 such as attendees, invitation text, documents, and location, to name just a few pieces of information. The meeting information 102 changes over the lifetime of the meeting. In other words, the meeting information 102 can be a continually changing aggregation of information created as part of preparation, in-meeting, and post-meeting stages. Alternatively, the meeting information 102 can represent selected portions of the overall information generated, changed, updated, and/or deleted during stages of the meeting lifecycle. For example, a user can employ a client scheduling application to schedule the meeting, and link documents for upload as part of the meeting start. This information can then be part of the meeting information 102.

The multiple stages can be associated with disparate lifecycle components 104 for generating and processing the meeting information 102. The meeting information 102 can include scheduling information and meeting content, for example. The framework 100 can also include a synchronization component 106 for automatically synchronizing the meeting information 102 among one or more of the lifecycle components 104.

The lifecycle components 104 can include a scheduling component 108, an in-meeting component 110, a content management component 112, and other components as well. The synchronization component 106 can be associated with a client application of the scheduling component 108, a client application of the in-meeting component 110, and/or a client application of the content management component 112, where each of the clients can synchronize the meeting information 102 or portions thereof to some or all of the lifecycle components 104. The dotted line indicates that the synchronization component 106 can communicate with one or more of the lifecycle components 104.

The disclosed framework 100 provides a complete end-to-end meeting lifecycle facilitating a seamless user experience across the core components and meeting stages. The multiple stages can include scheduling, pre-meeting, joining, in-meeting, and post-meeting stages, for example.

Each of the lifecycle components 104 can provide information to the synchronization component 106 in order to facilitate synchronization of some or all of the meeting information 102, as needed, between all other components. The scheduling component 108 can provide meeting information available at the time scheduling components are created, modified or deleted. This can include, but is not limited to, the time when the meeting is scheduled, when new invitations are generated, data synchronization, and/or when meeting invitations are updated. The in-meeting component 110 can provide meeting information available at the time the meeting is actually occurring, or information that resulted from the meeting itself. The content management component 112 can provide meeting information available between scheduling and the actual meeting occurrence as well as information that is updated after the meeting has already ended.

In a specific implementation, the scheduling component 108 can synchronize permissions for a meeting invitation, the in-meeting component 110 can create and store a meeting record (or recording), and the content management component 112 can store and playback the meeting record (or recording). The synchronization to one of the lifecycle components 104 initiates synchronization to the remaining lifecycle components. Synchronization can be initiated manually and/or automatically.

In other words, the scheduling component 108 functionality includes the synchronizing of data to both the in-meeting component 110 and content management component 112, the data including but not limited to, attendees, invitation text, documents, location, join URL (uniform resource locator), and audio dial-in information. Synchronization also can include permissions for the meeting invitation such as attendee roles (e.g., presenter or organizer). Selection from the scheduling component 108 can include the content management component 112 and the in-meeting component 110.

The content management component 112 comprises functionality related to editing meeting data, including but not limited to, attendee list, agenda/invitation text, documents, and attendance records. The storage and playback of the meeting recordings can be performed, as well as synchronization of data to both the scheduling and in-meeting components (108 and 110). The in-meeting component 110 can include the editing of meeting data, including but not limited to, attendee list, agenda/invitation text, documents, attendance records, etc., creating and storing the meeting recordings, and synchronizing data to both the scheduling component 108 and the content management component 112.

The synchronization component 106 includes the functionality to accommodate data synchronization when not connected to any of the lifecycle components (e.g., no Internet connectivity, no connectivity to the scheduling server, no connectivity to the document server, no connectivity to the meeting server, etc.). For example, the synchronization component 106 enqueues data for synchronization when the client goes offline and completes synchronization of the data when the client goes online. Logic and heuristics are included to manage the multi-master synchronization of the architecture.

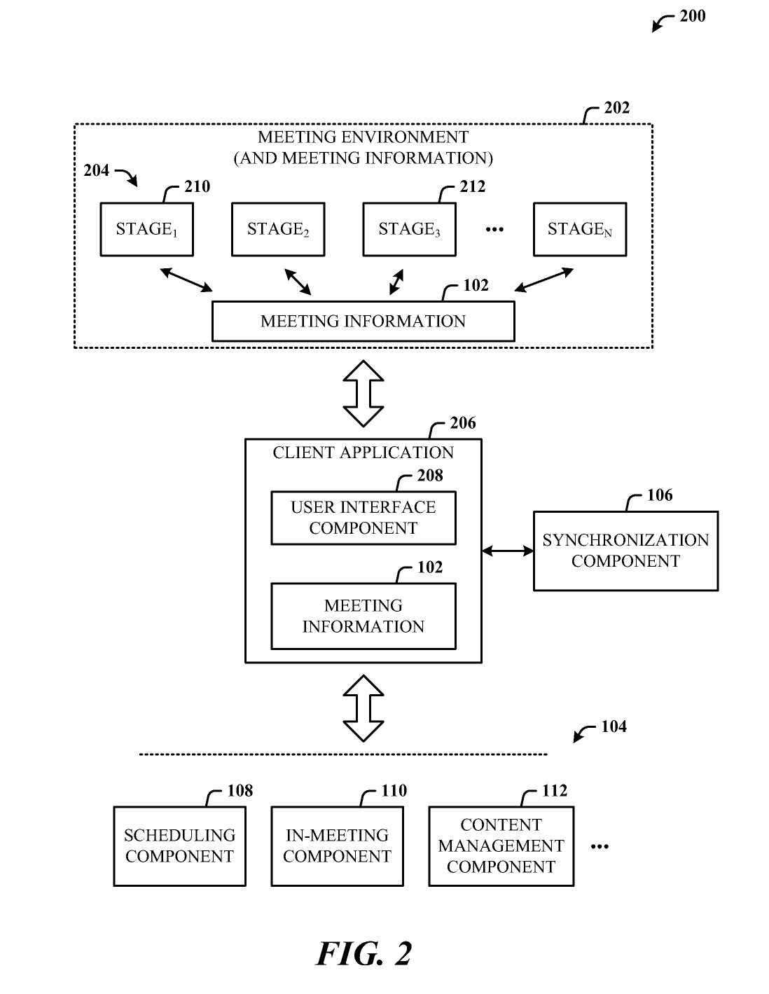

FIG. 2 illustrates a computer-implemented meeting lifecycle framework 200 that includes client-based synchronization. The framework 200 includes a conceptual representation of a meeting environment 202 of multiple stages 204 (Stage₁, Stage₂, . . . ,Stage_{N}) for preparing and conducting the meeting, the lifecycle components 104 for generating and processing the meeting information 102, and the synchronization component 106 for synchronizing the meeting information 102 among one or more of the lifecycle components 104. The lifecycle components 104 include the scheduling component 108, the in-meeting component 110, the content management component 112, and other components as well.

Note that as illustrated for clarity, the meeting environment 202 is shown separately and conceptually from the lifecycle components 104. In operation, the meeting environment 202, meeting information 102, and stages 204 are included as functionality and data provided by the lifecycle components 104. The meeting environment 202 and associated entities are described in greater detail herein.

The synchronization component 106 can be part of client application 206 that interfaces to one or more of the scheduling component 108, the in-meeting component 110, the content management component 112, and the other components. Thus, a user can interact with two or more of the lifecycle components 104. Changes to one of the lifecycle components 104 (e.g., the scheduling component 108) are synchronized to the other lifecycle components (e.g., the in-meeting component 110 and the content management component 112).

Alternatively, the client application 206 is a client to only one of the scheduling component 108, the in-meeting component 110, or the content management component 112. Again, changes to one of the lifecycle components 104 (e.g., the in-meeting component 110) are automatically synchronized to the other lifecycle components (e.g., the scheduling component 108 and the content management component 112).

The client application 206 of the framework 200 can further comprise a user interface component 208 for accessing and presenting some or all of the meeting information 102 associated with the multiple stages 204. The user interface component 208 can be used for presenting relevant data of the meeting information 102 during a stage of the meeting lifecycle as the meeting progresses through the stages 204. In other words, the meeting information presented via the user interface component 208 at a first stage 210 can be different or have some overlap with meeting information shown in a third stage 212.

Put another way, the framework 200 is a computer-implemented meeting lifecycle framework that comprises the meeting lifecycle components 104 for generating and processing meeting information 106 associated with multiple stages 204 of a meeting lifecycle, a client-based synchronization component 106 for automatically synchronizing the meeting information 102 among one or more of the lifecycle components 104, and a user interface component 208 for accessing and presenting the meeting information 102 as a seamless end-to-end meeting experience associated with the multiple stages 204.

The lifecycle components 104 include the in-meeting component 110 for creating and storing a meeting record, the content management component 112 for storage and playback of the meeting recording, and the scheduling component 108 for synchronizing permissions for a meeting invitation.

The multiple stages 204 can include a scheduling stage, a pre-meeting stage, a joining stage, an in-meeting stage, and a post-meeting stage, and the lifecycle components 104 can include the scheduling component 108, the in-meeting component 110, and/or the content management component 112. The lifecycle components 104 interact during the stages 204 to create, update, and store the meeting information 102 throughout the stages 204.

The synchronization of the meeting information 102 to one of the lifecycle components 104 automatically initiates synchronization of portions of the meeting information 102 to one or more of other lifecycle components 104. The content management component 112 can present aspects of the meeting that are interesting based on a stage of the meeting environment 202.

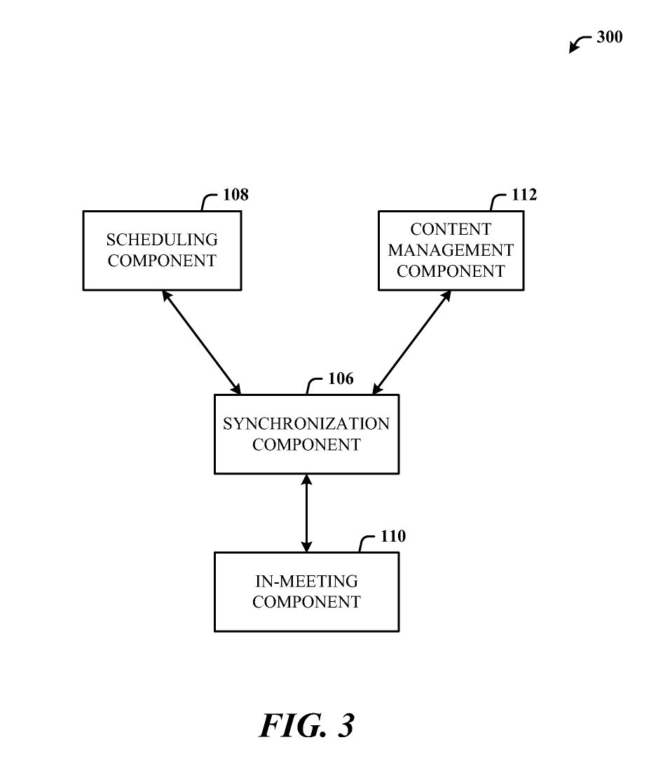

FIG. 3 illustrates a generalized system 300 for synchronizing meeting information between three lifecycle components. Here, the synchronization component 106 provides synchronization individually to each of the scheduling component 108, the in-meeting component 110, and the content management component 112. The system 300 shows that all synchronization occurs through the synchronization component 106 to the scheduling component 108, in-meeting component 110, and content management component 112. Additionally, synchronization by a client to any one of the components (108, 110 or 112) can be performed through the synchronization component 106 to the other components.

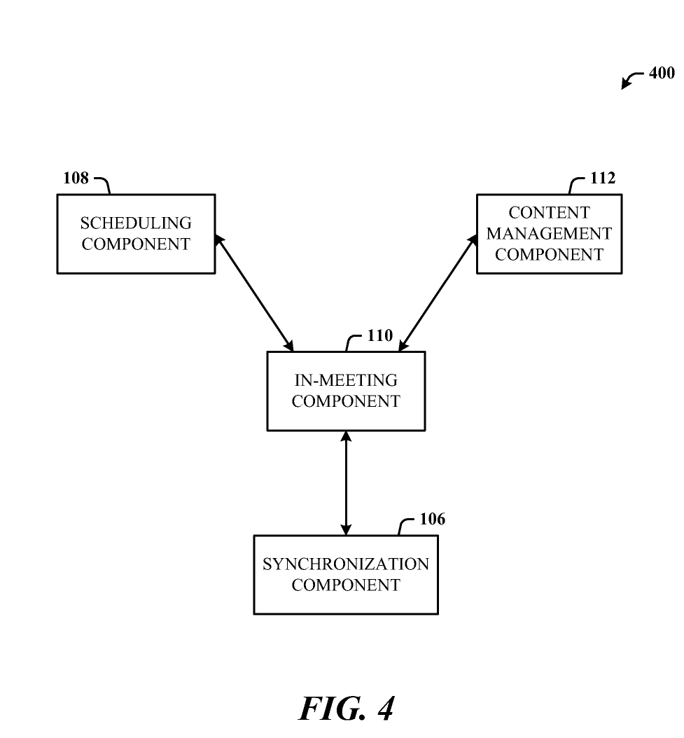

FIG. 4 illustrates that synchronization to one lifecycle component can automatically facilitate synchronization to the other lifecycle components. For example, the synchronization component 106 can be a client-side program that uploads meeting information to the in-meeting component 110. Thereafter, the in-meeting component 110, a service, performs server-side synchronization to the other lifecycle components (the scheduling component 108 and the content management component 112).

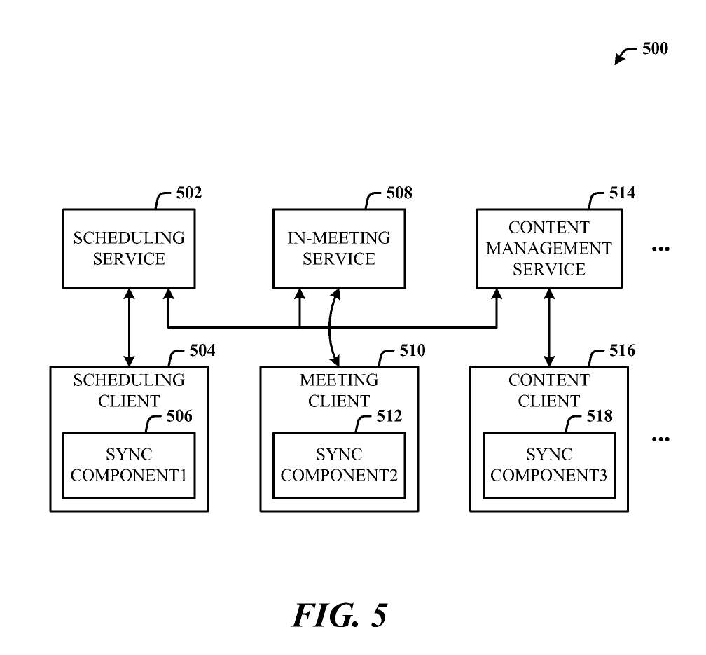

FIG. 5 illustrates a system 500 where lifecycle services communicate with a compatible client in a client-server relationship. Here, a scheduling service 502 interfaces to a scheduling client 504. The scheduling client 504 includes a first synchronization component 506 (Sync Component1) for synchronizing scheduling meeting information to the scheduling service 502 and other lifecycle services. Similarly, an in-meeting service 508 interfaces to a meeting client 510. The meeting client 510 includes a second synchronization component 512 (Sync Component2) for synchronizing scheduling meeting information to the scheduling service 502 and other lifecycle services. This further includes the meeting client 510 interacting with the in-meeting service 508 to effect recording (e.g., audio, video) of the meeting and storage of the recording. A content client 516 includes a third synchronization component 518 (Sync Component3) for synchronizing content data to a content management service 514.

Each of the meeting lifecycle components can have its associated synchronization component or the synchronization component can be independently situated. For example, if the clients are offline, client data is queued until such time as the clients are online and can then synchronize the data to respective services. It is to be appreciated that any data exchanged between the services, whether the clients are online or offline, can be synchronized on a purely server-side basis as well. If the clients are online, the server synchronization can work in cooperation with or independently of the client synchronization.

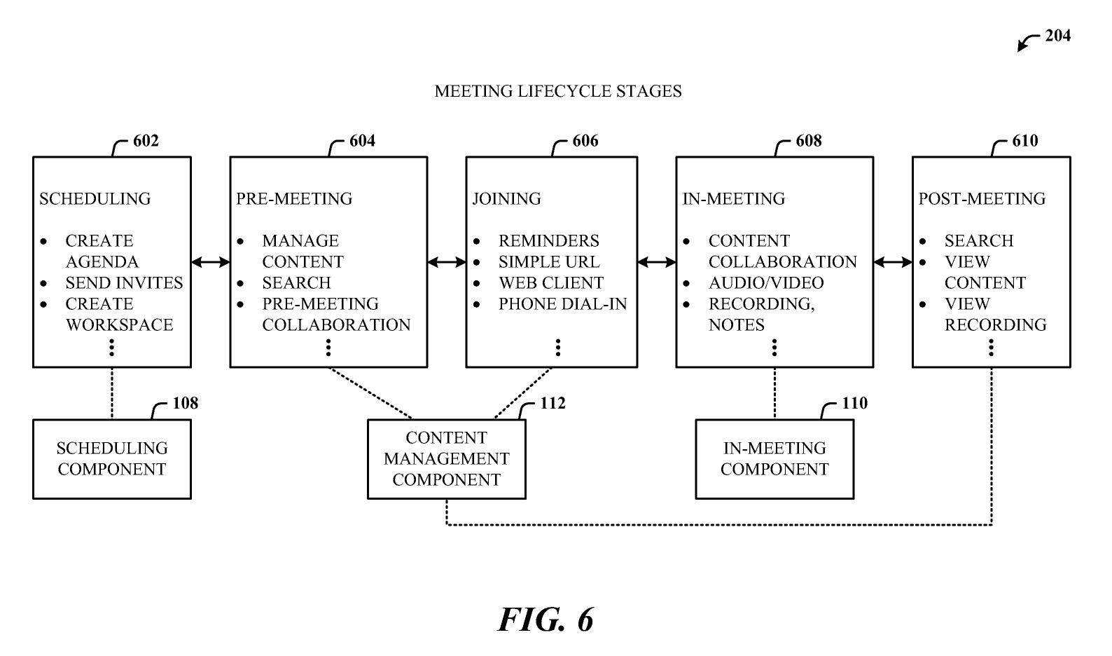

FIG. 6 illustrates one example of the stages 204 of a meeting lifecycle framework. A scheduling stage 602 provides a scheduling user experience (UX) that includes items such as creating an agenda, sending invites to meeting attendees, creating a workspace, and other related scheduling items. When a new meeting is scheduled using a PIM add-in (where the PIM can include message capability, as well as contacts, calendaring, and so on), a meeting page can be created on a content management website. The meeting page can be a container for all the meeting documents. For example, the meeting page can include basic meeting information, a meeting invitation body, agenda, participant list, documents, and recordings. A link to the meeting page can be displayed in a PIM calendar item so that users can easily access the meeting page. Documents attached to the calendar invitation are automatically uploaded to the meeting page.

Documents are converted to the appropriate format for the meeting and stored in a local copy as well as uploaded to the collaboration application (e.g., the document component) along with the original copy. The converted documents can be stored and not shown on the meeting page. A client also creates a local cache copy of content, which can be used for uploading the content to the collaboration application, if the client is not connected to the collaboration application at the time of meeting scheduling. The local cache can also be used later to populate content into a communications server (e.g., the meeting component) if the collaboration application is not available at the time of the meeting.

The add-in will create a reference to the meeting page in all the invitee's personal pages. This way, a user can see all the online meetings in their personal page and navigate to the meeting from there. If the user specifies that this meeting is associated with an existing collaboration application site, the add-in can also create a new calendar time in the team calendar for that site, and include a link to the meeting page.

The lifecycle stages 204 can also include a pre-meeting stage 604. The pre-meeting stage 604 provides a pre-meeting UX that includes items such as managing content, searching, pre-meeting collaboration, and so on. Before the meeting, users can upload documents directly to the meeting site or meeting page for discussion in the meeting. In addition to the meeting documents, the meeting page can provide other helpful information such as the address for joining the meeting (the Join URL) and a list of invitees.

In other words, before the meeting start, the client available on any one of the presenter machines pulls the converted documents from the collaboration site (e.g., the document component) and uploads the documents to the meeting service (e.g., a communications service). Original document can also be uploaded as handouts. Pre-conversion of documents assists in saving the meeting preparation time. The meeting service can act as a store for content while the collaboration service (e.g., the content management service 514) can be the actual content storage.

If a client does not have access to the collaboration service, the client will take the last good copy of the content from local content cache (content sent along with the meeting invite) and upload the content to meeting service. Content upload can be performed by any of the meeting participants who first connect into the meeting and have access to either the content management application or have a local cached copy of the content. The entire content upload to the meeting service can be is accomplished with no user intervention. For the user, the upload works seamlessly and transparently and all content is available in the meeting on the meeting service.

The lifecycle stages 204 can also include a join stage 606. The join stage 606 provides a UX that includes items (or actions) such as reminders, address (e.g., URL) from which to join the meeting, web client, phone dial-in, and so on. Upon joining an online meeting, the first user joining activates the conference. At the same time, the client accesses the collaboration site for this meeting to check for the latest versions of the meeting content. If it is more current than the local cached copy, new copies are downloaded from the collaboration meeting site. The content is then uploaded to a file content service for the meeting. This content is then shared to all the meeting attendees, such as corporate users or anonymous users, for example.

The lifecycle stages 204 can also include an in-meeting stage 608. The in-meeting stage 608 provides a UX that includes items (or actions) such as content collaboration, audio and video, recordings, notes, and so on. Users join the realtime meeting and the content is already available without having to take extra steps. Original documents are available as handouts, and converted documents are available for viewing. Linked documents (e.g., linked to the collaboration service) are automatically pulled into the meeting, if access to the collaboration service is available. During the meeting, users can add new documents to the meeting, new content can be created in the form of whiteboards, questions and answers, notes, edits to existing documents, recordings, etc.

The lifecycle stages 204 can also include a post-meeting stage 610. The post-meeting stage 610 provides a UX that includes items (or actions) such as searching, viewing content, viewing recording(s), and so on. After the meeting ends, all the new content (including recordings) can be automatically saved to the collaboration meeting page. From the meeting, there is content that can be viewed only in the meeting console. This content can be stored in a UI element in the collaboration service and only be viewed when user opens the meeting console.

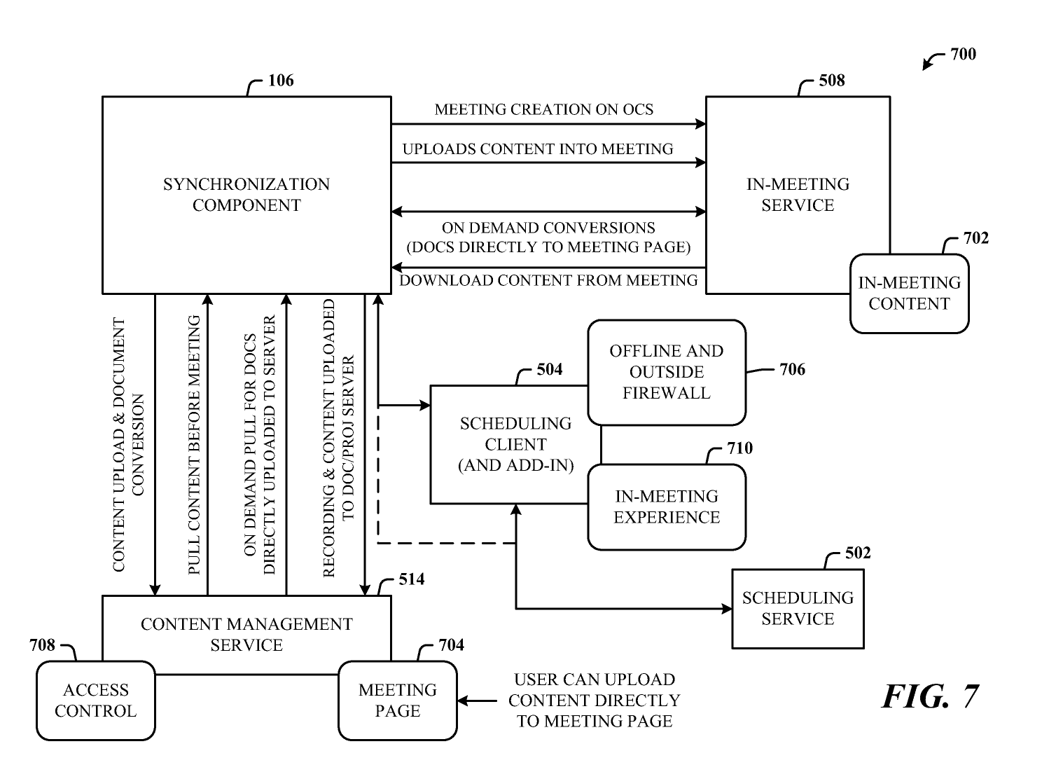

FIG. 7 illustrates one implementation of a system 700 showing components and data flow. The system 700 includes the meetings service 508, which facilitates the upload and download of content, and sends notification on meeting completion, for example. In-meeting content 702 is associated with the meeting service 508, and can include original documents uploaded from the client 504 (through the synchronization component 106), converted documents from the client 504, linked documents are inflated to the meeting, and documents can be uploaded directly to a meeting page 704. The scheduling client 504 can indirectly interface to the meeting service 508 (through the synchronization component 106) to create a meeting on the meeting service 508. The scheduling client 504 can also upload content into the meeting.

The client 504 can select a collaboration site, provide an email invitation form, create the collaboration meeting site, upload meeting content to the meeting page 704, and upload content to the meeting service 508. When offline and/or outside a firewall as indicated at 706, the client 504 caches a list of available collaboration sites, retries creation of the meeting site, uploads original and converted documents, provides notification for failures, and caches copies of the originals and converted content.

The content management service 514 can be a collaboration site that supports one meeting for one meeting site, one meeting site supports multiple meeting pages, one service supports multiple meeting sites, and multiple content management services can be employed to load balance.

An access control component 708 facilitates access to the content management service 514 for creating sites, and access to individual meeting sites is based on a meeting participant list. The meeting page 704 provides original and converted documents, references to linked documents, meeting agenda and participant lists, and metadata about the meeting (e.g., meeting URI-uniform resource identifier). An in-meeting experience 710 provided by the above services and capabilities makes the original documents available as handouts, converted documents for viewing, linked documents can be pulled into the meeting, and directly uploaded documents get converted on demand. The in-meeting experience 710 interacts with the meeting service 508. The in-meeting content 702 can upload to the meeting service 508 directly via the experience 710.

The scheduling client 504 is shown to interface to the synchronization component 106 as well. Optionally, the scheduling service 502 can be employed to interact directly with the scheduling client 504. However, in an alternative implementation, the scheduling service 502 can interface directly to the synchronization component 106 (as indicated by the dashed line).

When an online meeting is scheduled, a meeting site is created in the content management service 514 (e.g., that includes a collaboration application). The proper access control is set for the attendees to the meeting. Documents attached or linked to the meeting invite are uploaded to the same site. The site shows the roster and join link to the meeting. The meeting page 704 allows users to join immediately. The meeting page 704 allows users to see if the meeting is active, and the identity of the attendees. The meeting page 704 allows users to add the event to their PIM calendar. When the online meeting starts, documents in the content management service 514 and from the meeting site are automatically uploaded to the in-meeting service 508, and made available to some or all participants of the meeting. New documents uploaded during the meeting are periodically uploaded to the meeting page 704. Client-side recordings are also uploaded to the meeting page 704.

The meeting page 704 also supports recurring meetings. Permission changes during the meeting are reflected immediately in the access control 708 on the meeting page 704. A web client is able to consume the in-meeting content 702. Users are able to upload new content to the content management service 514 before the meeting. The content 702 can also be automatically uploaded when the meeting starts. New content uploaded by a client can also be uploaded to the content management service 514.

During an online meeting, users can upload new content to the meeting. This content will also be automatically uploaded to the meeting site. During the meeting, if the presenters add or remove attendees to the meeting, these actions are reflected in the site as soon as possible. When the meeting ends, the meeting state and recordings of the meeting are uploaded to the content management service 514. Additionally, a mechanism is provided in which meeting sites with a certain age will be automatically archived and deleted. The longer the meeting has past, the more irrelevant the related meeting content.

In a more specific description of some aspects of the meeting lifecycle framework, a meeting site is created when a PIM application schedules an online meeting. The provisioning work can be performed using a communications client. A PIM add-in can call into the communications client via a communications interface accomplish the provisioning.

The following can occur during PIM meeting scheduling (for online meetings): the PIM sets up the meeting via a messaging server (via MAPI-messaging application programming interface). The PIM add-in sets up the meeting in a communications service (e.g., via SIP-session initiation protocol). The PIM add-in calls the communications client to provisioning in the content management service.

The communications client then creates a meeting site for the meeting, adds presenters and attendees into the meeting site, and assigns appropriate permissions (presenters have read/write permission while attendees only have read permission). The communications client also uploads email attachments, if any, to the meeting site's document library, and creates links to the meeting site, creates events from a calendar. The PIM includes the URL of the newly-created meeting site in the meeting invite, and sends the URL to attendees in a message.

There can be one document library per meeting (including recurring meetings). Each meeting document library can have multiple files. Some files are converted content only for communications client consumption and are not viewable for users from the content management service. In some case, it may just be a link to a document.

Upload of documents to the document library can be achieved by HTTP PUT messages, for example, to the document library URL. When a web service detects that a file is available, information is extracted from the file such as last modified, who's the owner, etc., and surfaces an entry in the document library. The URL is constructed by the web service as well. To access this document library, the meeting site URL and GUID (globally unique identifier) of the document library are utilized. The GUID can be retrieved through web services calls.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

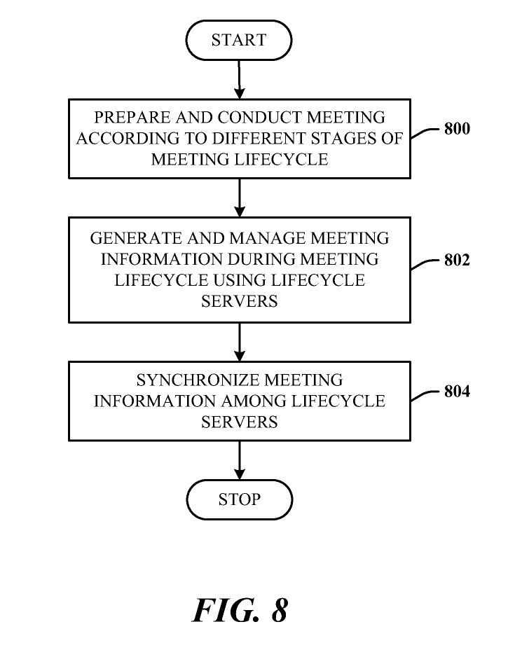

FIG. 8 illustrates a computer-implemented meeting lifecycle method. At 800, a meeting is prepared and conducted according to different stages of a meeting lifecycle. At 802, meeting information is generated and managed during the meeting lifecycle using lifecycle services. At 804, the meeting information is synchronized among the lifecycle services. Note that although represented linearly in the flow chart, it may not be the case that the stages are purely linear. For example, flow can alternatively be from 800 to 802, and then back to 800. Additionally, synchronization at 804 can occur continuously.

The method can further comprise presenting relevant data of the meeting information during a stage of the meeting lifecycle. As previously described, the meeting information is synchronized among the lifecycle services via a client application associated with one of the lifecycle services.

The method can further comprise linking a content management service to a scheduling server to update invitation text. The method can further comprise storing and playing back a meeting record during a stage of the meeting lifecycle, and synchronizing permissions for a meeting invitation among the lifecycle services.

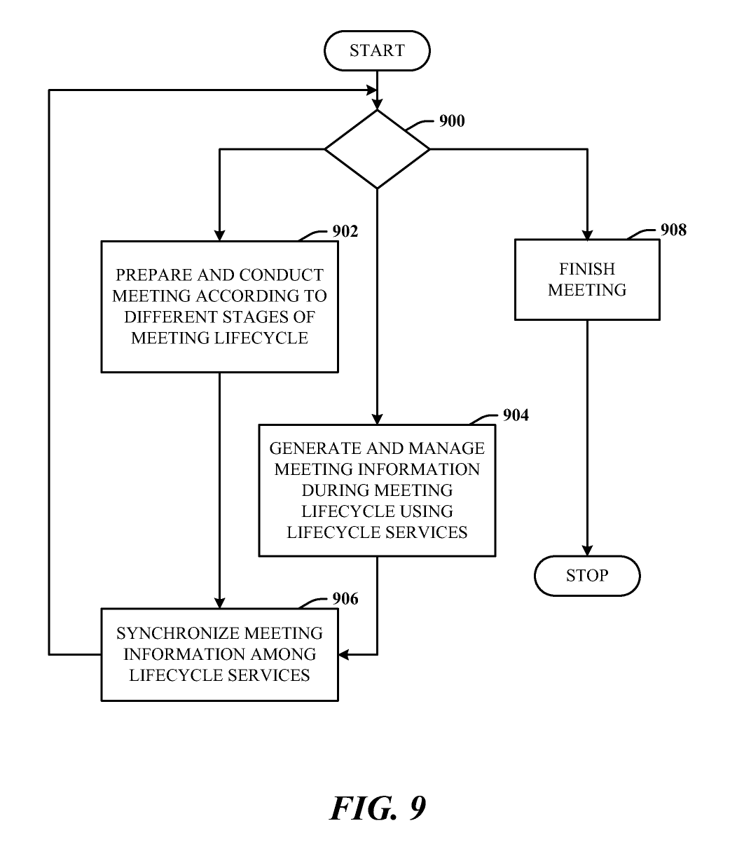

FIG. 9 illustrates an alternative flow for a meeting lifecycle method. At 900, a decision is made whether to (at 902) prepare and conduct the meeting according to different stages of the meeting lifecycle, to (at 904) generate and manage the meeting information during the meeting lifecycle using the lifecycle services, or finishing the meeting, at 908. Following both instances of 902 and 904, flow is to 906 to synchronize the meeting information among the lifecycle services. Flow is then back to 900. Alternatively, from 900, flow can be to finish the meeting, as 908.

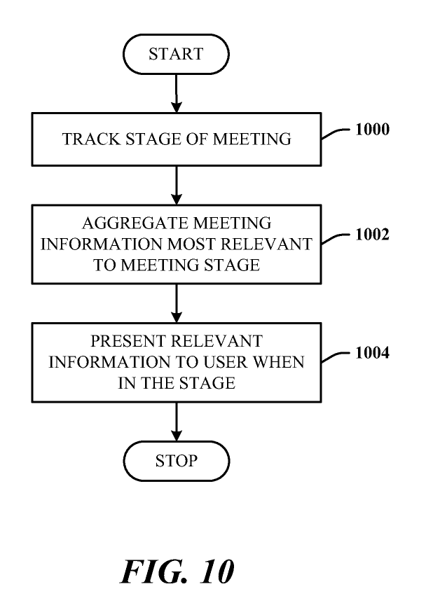

FIG. 10 illustrates a method of presenting relevant meeting information during a stage of the lifecycle framework. At 1000, the stages of the meeting are tracked. At 1002, meeting information most relevant to a meeting stage is aggregated. At 1004, the relevant information is presented to the user while in the stage.

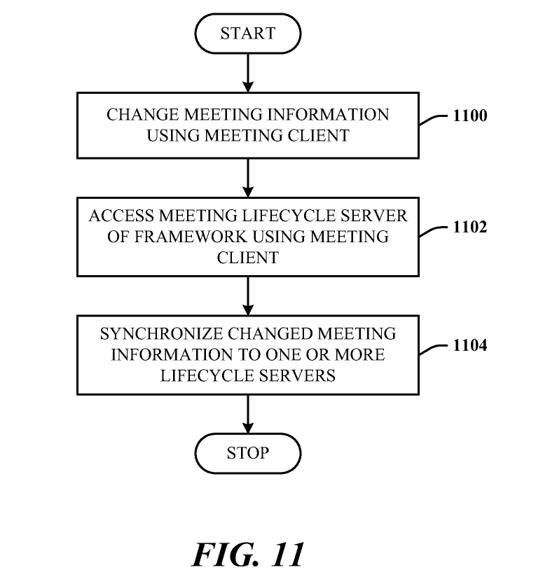

FIG. 11 illustrates a method of synchronizing meeting information to meeting lifecycle services. At 1100, meeting information is changed using a meeting client. At 1102, a meeting lifecycle service of a lifecycle framework is accessed using the meeting client. At 1104, the changed meeting information is synchronized to one or more of the lifecycle services.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

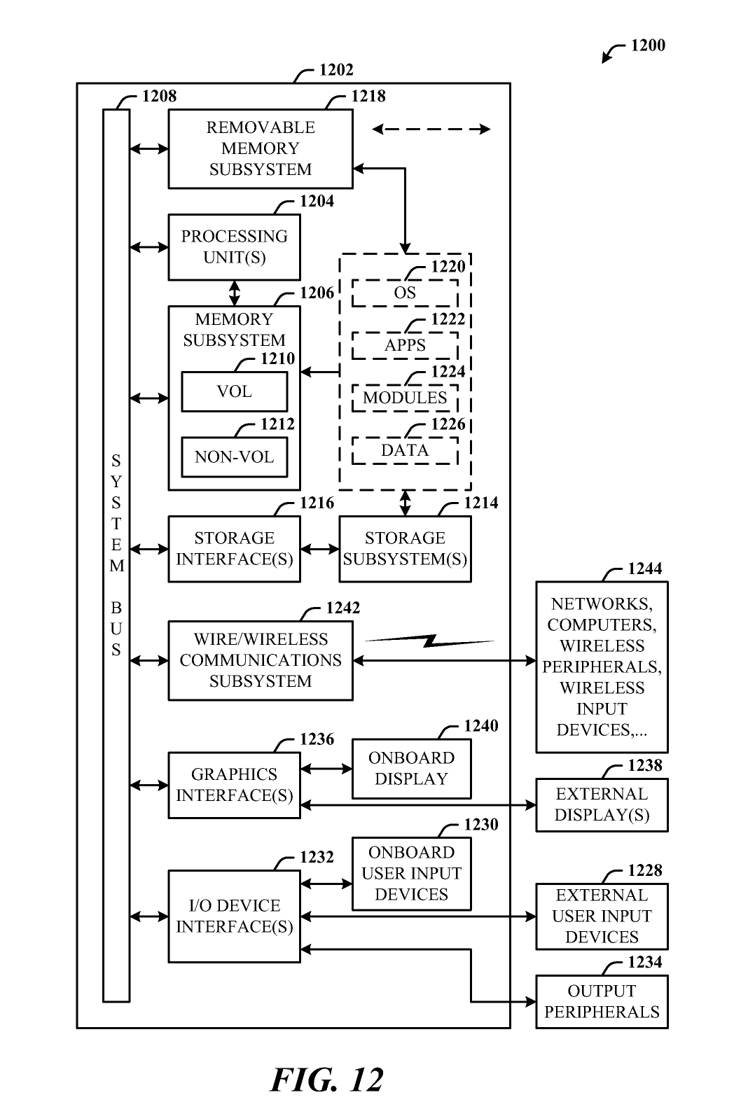

Referring now to FIG. 12, there is illustrated a block diagram of a computing system 1200 operable to execute client synchronization of meeting information in accordance with the disclosed architecture. In order to provide additional context for various aspects thereof, FIG. 12 and the following discussion are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204, a system memory 1206, and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1206 can include volatile (VOL) memory 1210 (e.g., random access memory (RAM)) and non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the memory subsystem 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes storage subsystem(s) 1214 and storage interface(s) 1216 for interfacing the storage subsystem(s) 1214 to the system bus 1208 and other desired computer components. The storage subsystem(s) 1214 can include one or more of a hard disk drive (HDD), a magnetic floppy disk drive (FDD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a removable memory subsystem 1218 (e.g., flash drive form factor technology), and/or the storage subsystem(s) 1214, including an operating system 1220, one or more application programs 1222, other program modules 1224, and program data 1226. Generally, programs include routines, methods, data structures, other software components, etc., that perform particular tasks or implement particular abstract data types.

Where the computer 1202 is a client machine, the one or more application programs 1222, other program modules 1224, and program data 1226 can include the synchronization component 106, the client application 206, the user interface component 208, scheduling client 504 and first synchronization component 506, the meeting client 510 and second synchronization component 512, and the content management client 516 and third synchronization component 518. Where the computer 1202 is a server machine, the one or more application programs 1222, other program modules 1224, and program data 1226 can include the scheduling component 108, in-meeting component 110, content management component 112, the scheduling service 502, meeting service 508, the content management service 514, and the methods of FIGS. 8-11, for example.

All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Computer readable media can be any available media that can be accessed by the computer 1202 and includes volatile and non-volatile media, removable and non-removable media. For the computer 1202, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1202, programs, and data using external user input devices 1228 such as a keyboard and a mouse. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example. These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP) using logical connections via a wire/wireless communications subsystem 1242 to one or more networks and/or other computers. The other computers can include workstations, servers, routers, personal computers, microprocessor-based entertainment appliance, a peer device or other common network node, and typically include many or all of the elements described relative to the computer 1202. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wire/wireless communication subsystem 1242 (e.g., a network interface adapter, onboard transceiver subsystem, etc.) to communicate with wire/wireless networks, wire/wireless printers, wire/wireless input devices 1244, and so on. The computer 1202 can include a modem or has other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

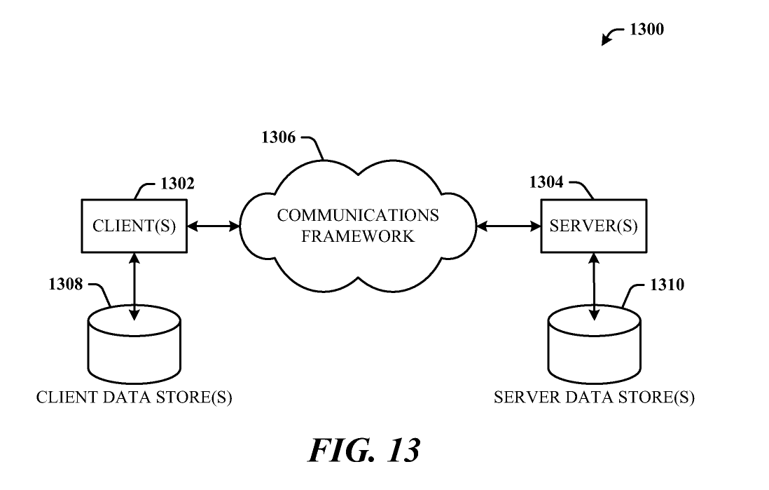

Referring now to FIG. 13, there is illustrated a schematic block diagram of a computing environment 1300 for meeting lifecycle client-based data synchronization. The environment 1300 includes one or more client(s) 1302. The client(s) 1302 can be hardware and/or software (e.g., threads, processes, computing devices). The client(s) 1302 can house cookie(s) and/or associated contextual information, for example.

The environment 1300 also includes one or more server(s) 1304. The server(s) 1304 can also be hardware and/or software (e.g., threads, processes, computing devices). The servers 1304 can house threads to perform transformations by employing the architecture, for example. One possible communication between a client 1302 and a server 1304 can be in the form of a data packet adapted to be transmitted between two or more computer processes. The data packet may include a cookie and/or associated contextual information, for example. The environment 1300 includes a communication framework 1306 (e.g., a global communication network such as the Internet) that can be employed to facilitate communications between the client(s) 1302 and the server(s) 1304.

Communications can be facilitated via a wire (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented meeting lifecycle framework, comprising:
meeting lifecycle components for generating and processing meeting information associated with multiple stages of a meeting lifecycle; and
a synchronization component for automatically synchronizing the meeting information among one or more of the lifecycle components.

2. The framework of claim 1, wherein the lifecycle components include at least two of a scheduling component, a meeting component, or a content management component, the combination of which provide a seamless end-to-end user experience during the meeting lifecycle.

3. The framework of claim 2, wherein the synchronization component is associated with at least one of a client application of the scheduling component, a client application of the meeting component, or a client application of the content management component, one or more of the clients that synchronize the meeting information to all of the lifecycle components.

4. The framework of claim 1, wherein the multiple stages include scheduling, pre-meeting, joining, in-meeting, and post-meeting.

5. The framework of claim 1, wherein the synchronization component is part of a client, the synchronization component enqueues data for synchronization when the client goes offline and completes synchronization of the data when the client goes online.

6. The framework of claim 1, further comprising a user interface component for accessing and presenting the meeting information associated with the multiple stages.

7. The framework of claim 1, wherein the lifecycle components include a meeting component for creating and storing a meeting recording and, a content management component for storage and playback of the meeting recording.

8. The framework of claim 1, wherein the lifecycle components include a scheduling component for synchronizing permissions for a meeting invitation.

9. The framework of claim 1, wherein the synchronization to one of the lifecycle components automatically initiates synchronization to the remaining lifecycle components.

10. A computer-implemented meeting lifecycle framework, comprising:
meeting lifecycle components for generating and processing meeting information associated with multiple stages of a meeting lifecycle;
a client-based synchronization component for automatically synchronizing the meeting information among one or more of the lifecycle components; and
a user interface component for accessing and presenting the meeting information as a seamless end-to-end meeting experience associated with the multiple stages.

11. The framework of claim 10, wherein the lifecycle components include a meeting component for creating and storing a meeting recording, a content management component for storage and playback of the meeting recording, and a scheduling component for synchronizing permissions for a meeting invitation.

12. The framework of claim 10, wherein the multiple stages include a scheduling stage, a pre-meeting stage, a joining stage, an in-meeting stage, and a post-meeting stage, and the lifecycle components include a scheduling component, a meeting component, or a content management component, the lifecycle components interacting during the stages to create, update, and store the meeting information throughout the stages.

13. The framework of claim 10, wherein the synchronization of the meeting information to one of the lifecycle components automatically initiates synchronization of portions of the meeting information to one or more of other lifecycle components.

14. The framework of claim 10, wherein the lifecycle components include a content management component for presenting aspects of the meeting that are interesting based on a stage of the lifecycle framework.

15. A computer-implemented meeting lifecycle method, comprising:
preparing and conducting a meeting according to different stages of a meeting lifecycle;
generating and managing meeting information during the meeting lifecycle using lifecycle servers; and
synchronizing the meeting information among the lifecycle servers.

16. The method of claim 15, further comprising presenting relevant data of the meeting information during a stage of the meeting lifecycle.

17. The method of claim 15, wherein the meeting information is synchronized among the lifecycle servers via a client application associated with one of the lifecycle servers.

18. The method of claim 15, further comprising linking a content management server to a scheduling server to update invitation text.

19. The method of claim 15, further comprising storing and playing back a meeting recording during a stage of the meeting lifecycle.

20. The method of claim 15, further comprising synchronizing permissions for a meeting invitation among the lifecycle servers.
